(19) United States
(12) Patent Application Publication
(10) Pub. No.: US 2011/0053032 A1
(43) Pub. Date: Mar. 3, 2011

(54) MANIFOLD FOR SERIES CONNECTION ON FUEL CELL

(76) Inventors: Jae Hyoung Gil, Seoul (KR); Jae Hyuk Jang, Gyunggi-do (KR); Kyong Bok Min, Gyunggi-do (KR); Sung Han Kim, Seoul (KR); Hong Ryul Lee, Gyunggi-do (KR)

(21) Appl. No.: 12/609,899

(22) Filed: Oct. 30, 2009

(30) Foreign Application Priority Data
Aug. 31, 2009 (KR) 10-2009-0081189

(51) Int. Cl. H01M 2/00

(52) U.S. Cl. 429/458; 429/535

(57) ABSTRACT

Disclosed is a manifold of a fuel cell, including a conductive support having an upper support member and a lower support member between which two or more anode-supported tubular unit fuel cells each comprising an anode layer, an electrolyte layer and a cathode layer formed in sequential order are disposed and which include an inner connector and an outer connector formed to be tightly fitted into an inner surface and around an outer surface of the unit fuel cells so as to electrically conduct the unit fuel cells, such that the unit fuel cells are alternately connected with the inner connector and the outer connector at an upper end and a lower end thereof thus forming an electrical series circuit. The manifold which is essentially manufactured to supply fuel to a solid oxide fuel cell is used to simply collect current from the fuel cell even without an additional current collector being used, and is configured such that unit fuel cells disposed in the manifold are connected in series.

### CROSS REFERENCE TO RELATED APPLICATION

This application claims the benefit of Korean Patent Application No. 10-2009-0081189, filed Aug. 31, 2009, entitled “Manifold for series connection of fuel cell”, which is hereby incorporated by reference in its entirety into this application.

### BACKGROUND OF THE INVENTION

1. Technical Field

The present invention relates to a manifold of a fuel cell.

2. Description of the Related Art

As environmental pollution gradually increases, global warming problems are becoming more serious. For this reason, the Kyoto protocol was adopted in 1997 in order to set guidelines for the reduction of carbon dioxide emission and to handle energy-related environmental problems in earnest. Thus, fuel cell technology which exhibits high cell performance and is environmentally friendly is receiving renewed attention.

A fuel cell is a device for directly converting the chemical energy of fuel (hydrogen, LNG, LPG, etc.) and air into electric power and heat using an electrochemical reaction. Unlike conventional techniques for generating power including combusting fuel, generating steam, driving a turbine and driving a power generator, the fuel cell neither undergoes a combustion procedure nor requires an operator and is thus regarded as a novel power generation technique which results in high cell performance without being accompanied by any concomitant environmental problems. The fuel cell discharges very small amounts of air pollutants such as SOx and NOx and also generates a small amount of carbon dioxide and is thus a pollution-free power generator, and is furthermore advantageous in terms of producing very little noise and not causing any vibrations.

The fuel cell includes for example a phosphoric acid fuel cell (PAFC), an alkaline fuel cell (AFC), a polymer electrolyte membrane fuel cell (PEMFC), a direct methanol fuel cell (DMFC), a solid oxide fuel cell (SOFC) and so on. In particular, the SOFC exhibits high power generation efficiency because of low overvoltage based on activation polarization and low irreversible loss. Furthermore, the SOFC is advantageous because various types of fuel, such as hydrogen, carbon and a hydrocarbon, may be used, and also because the reaction rate at the electrodes is high, thus obviating a need to use an expensive noble metal as an electrode catalyst. Moreover, the temperature of the heat generated during power generation is very high, and thus the heat is very usable. In addition, heat generated from the SOFC is used to reform fuel and may also be utilized as an energy source for industrial purposes or for air cooling in a cogeneration system. Hence, the SOFC is essential for realizing the hydrogen-based society of the future.

In accordance with the operating principle of the SOFC, the SOFC typically generates power through the oxidation of hydrogen or carbon monoxide, and the reactions at the anode and cathode are represented by Reaction 1 below.

Anode: H₂+O²⁻→H₂O+2e

CO+O²⁻→CO₂+2e

Cathode: O₂+4e→2O²⁻

Overall Reaction: H₂+½O₂→H₂O Reaction 1

In the above reactions, electrons are delivered to the cathode through an external circuit, and simultaneously the oxygen ion generated at the cathode is transferred to the anode through an electrolyte. At the anode, hydrogen or carbon monoxide is combined with the oxygen ion, thus producing electrons and water or carbon dioxide.

The SOFC discharges very small amounts of air pollutants such as SOx and NOx and generates a small amount of carbon dioxide and is thus a pollution-free power generator, and is also advantageous in terms of producing very little noise and not causing any vibrations.

Meanwhile, the connection method of the SOFC is either a series connection method or a parallel connection method. However, even if any one of the cells connected in series fails to operate, all of the cells connected in series do not operate, undesirably causing problems related to reliability and stability. Owing to these problems, a parallel connection method is desirably employed. Generally, an SOFC stack is formed by using parallel and series connection methods together. However, because the series connection method allows the cells to operate at higher voltage and lower current compared to the parallel connection method, voltage drop due to resistance is low upon connection. Thus, the series connection method is regarded as more efficient compared to the parallel connection method, and therefore, attempts for efficient series connection of the SOFC continue.

FIG. 1 schematically shows a conventional series connection. With reference to FIG. 1, cells are connected in such a manner that a portion of an electrode of a cell is exposed through partial masking, coated with a ceramic interconnector material 11, and then bonded to another cell, thus easily achieving series connection of the cells. However, the cell fabrication process becomes complicated, and also, an anode 12 and a cathode 13 should be bonded using a current collection material such as a nickel pelt 14, which is thus involved. Furthermore, buffers 15 should be provided to ensuing spaces for preventing the cells connected in series from coming into contact with the other cells not connected in series, and also, to reduce contact resistance, the cells should be pressed at predetermined pressure.

In addition, Japanese Unexamined Patent Publication No. 2007-149618 discloses a fuel cell structure for collecting current. However, this patent is disadvantageous because intermediate current collectors are provided between cells, undesirably incurring problems related to a bonding process and a complicated manufacturing process.

### SUMMARY OF THE INVENTION

Accordingly, the present invention has been made keeping in mind the problems encountered in the related art and the present invention is intended to provide a manifold being essentially manufactured to supply fuel to a fuel cell, which is used to collect current from the fuel cell and is configured such that unit fuel cells are connected in series without making recourse to an additional complicated process.

An aspect of the present invention provides a conductive manifold, including a conductive support including an upper support member and a lower support member between which two or more anode-supported tubular unit fuel cells each having an anode layer, an electrolyte layer and a cathode layer formed in sequential order are disposed and which include an inner connector and an outer connector formed to be tightly fitted into an inner surface and around an outer surface of the unit fuel cells so as to electrically connect the unit fuel cells, such that the unit fuel cells are alternately connected with the inner connector and the outer connector at an upper end and a lower end thereof thus forming an electrical series circuit.

In this aspect, a current collector connected to the cathode layer may be formed at one end of the upper support member of the manifold, and a current collector connected to the anode layer may be formed at the other end thereof.

In this aspect, the conductive support may include an insulator in order to prevent current from shorting.

In this aspect, the unit fuel cells may further include a current collection layer formed on each of the anode layer and the cathode layer.

In this aspect, the current collector may be connected to the anode layer or the cathode layer using an additional lead wire.

In this aspect, the manifold may have a fuel passage for supplying fuel into the unit fuel cells.

In this aspect, the unit fuel cells may be spaced apart from the upper support member and the lower support member of the conductive manifold by tightly fitting the inner connector and the outer connector of the manifold into and around the unit fuel cells.

As such, an insulator may be fixedly provided at a space between the unit fuel cells and the upper support member and the lower support member of the conductive manifold, which are spaced apart from each other.

In this aspect, the unit fuel cells and the manifold may be bonded using a brazing process.

In this aspect, the unit fuel cells and the manifold may be bonded by bringing conductive ink into direct contact with the unit fuel cells and the manifold and then performing sintering.

Another aspect of the present invention provides a conductive manifold, including a conductive support including an upper support member and a lower support member between which two or more cathode-supported tubular unit fuel cells each having a cathode layer, an electrolyte layer and an anode layer formed in sequential order are disposed and which include an inner connector and an outer connector formed to be tightly fitted into an inner surface and around an outer surface of the unit fuel cells so as to electrically connect the unit fuel cells, such that the unit fuel cells are alternately connected with the inner connector and the outer connector at an upper end and a lower end thereof thus forming an electrical series circuit.

### BRIEF DESCRIPTION OF THE DRAWINGS

The features and advantages of the present invention will be more clearly understood from the following detailed description taken in conjunction with the accompanying drawings, in which:

FIG. 1 is a top plan view schematically showing a fuel cell configuration according to a conventional series connection technique;

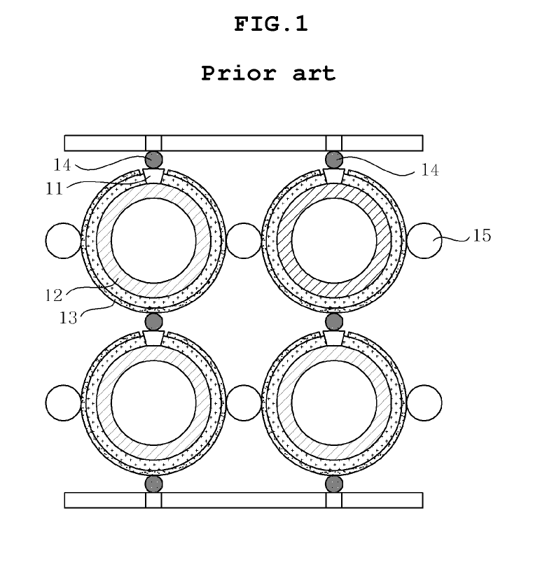

FIG. 2 is an elevational view schematically showing a manifold according to the present invention, in which a plurality of anode-supported unit fuel cells is disposed;

FIG. 3 is a cross-sectional view schematically showing the manifold according to the present invention, in which a plurality of anode-supported unit fuel cells is disposed; and

FIG. 4 is a cross-sectional view schematically showing a manifold according to the present invention, in which a plurality of cathode-supported unit fuel cells is disposed.

### DESCRIPTION OF SPECIFIC EMBODIMENTS

Hereinafter, a detailed description will be given of embodiments of the present invention with reference to the accompanying drawings. Throughout the drawings, the same reference numerals refer to the same or similar elements. Also in the drawings, O₂ and H₂ are used merely for purposes of illustration to specify the operative procedure of a fuel cell but the type of gas supplied to an anode or a cathode is not restricted. In the description, in the case where known techniques pertaining to the present invention are regarded as unnecessary because they make the characteristics of the invention unclear and also for the sake of description, the detailed descriptions thereof may be omitted.

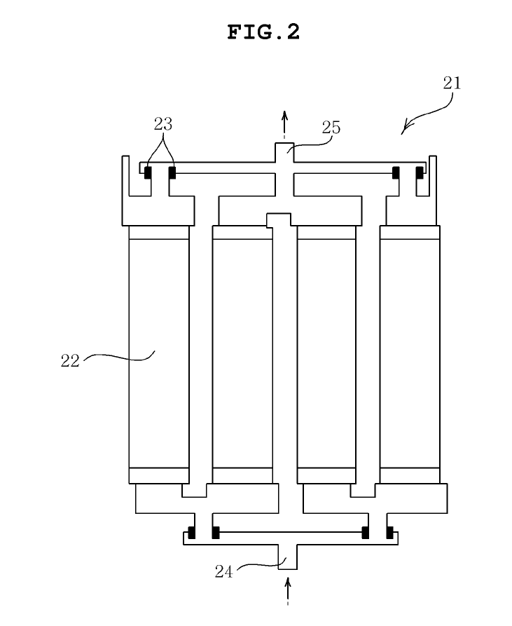

FIG. 2 is an elevational view schematically showing a manifold according to the present invention, in which a plurality of anode-supported unit fuel cells is disposed. The manifold 21, including upper and lower support members between which a plurality of unit fuel cells 22 is disposed, is configured such that fuel or air is easily supplied to the plurality of unit fuel cells and respective unit fuel cells may be connected in series.

To this end, the manifold is made of a conductive material. In the case where the conductive material is a metal, the metal may be selected from the group consisting of Fe, Cu, Al, Ni, Cr, alloys thereof and combinations thereof, in consideration of how strong it has to be.

Also in order to prevent the current from shorting, the manifold 21 includes insulators 23 at upper and lower portions thereof. Further, the manifold 21 may include a fuel inlet 24 which introduces fuel into the lower portion of the manifold 21 and a fuel outlet 25 which discharges fuel out of the upper portion of the manifold 21.

Fuel introduced into the fuel inlet 24 passes through the inside of the unit fuel cells 22 and thus causes the following reaction.

H₂+O²⁻→H₂O+2e⁻

CO+O₂→CO₂+2e⁻

An air atmosphere is formed outside the unit fuel cells 22. Accordingly, the following reaction occurs at the cathode.

½O₂+2e⁻→O²⁻

As electrons thus formed migrate, current is produced.

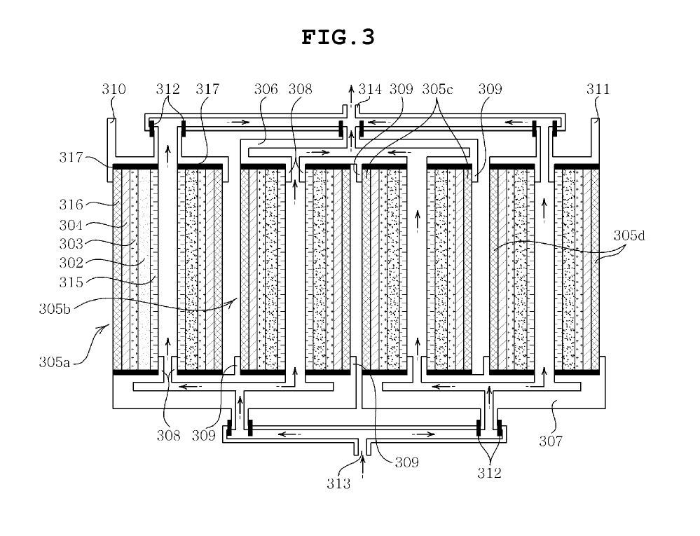

The respective unit fuel cells 22 disposed in the manifold 21 are connected in series by means of the manifold, which is described below with reference to FIG. 3.

FIG. 3 is a cross-sectional view showing the manifold of FIG. 2 in which the plurality of anode-supported unit fuel cells is disposed.

As shown in FIG. 3, a manifold 301 according to the present invention includes a conductive support in which one or more anode-supported tubular unit fuel cells 305 each having an anode layer 302, an electrolyte layer 303 and a cathode layer 304 formed in sequential order are disposed. For the sake of description, the manifold 301 in which four unit fuel cells 305 are disposed is illustratively disclosed in FIG. 3, but the present invention is not limited thereto.

The cathode is typically made of a Perovskite type oxide. Particularly useful is lanthanum strontium manganite (La_{0.84}Sr_{0.16})MnO₃ having high catalytic performance and high electronic conductivity. Oxygen is converted into the oxygen ion through the catalytic action of LaMnO₃. The Perovskite type oxide containing the transition metal has both ionic conductivity and electronic conductivity, and thus is efficiently used in the cathode. However, Perovskite other than the manganite may cause a chemical reaction with YSZ used in the electrolyte, undesirably creating a concern about the deterioration of performance of the electrode. In particular, LaCoO₃-based Perovskite is a material having high electrode catalyst activity but it chemically reacts with YSZ and has a different coefficient of thermal expansion, and thus is considered to be a material which is inappropriate for use in an electrode. Except for these materials which have just been mentioned, the cathode may be made of any other type of material which is appropriate for use therein.

The anode may be made of metal nickel/oxide ion conductor cermet. The metal nickel has high electronic conductivity and adsorbs hydrogen and hydrocarbon fuel, thus exhibiting excellent electrode catalyst activity. Compared to platinum and so on, nickel is inexpensive and therefore an advantageous electrode material. In the case of an SOFC operating at high temperature, a material (Ni/YSZ cermet) obtained by sintering nickel oxide power containing 40˜60% zirconia power may be used. However, the present invention is not limited to this material.

Because a solid oxide electrolyte has lower ionic conductivity than that of a liquid electrolyte such as an aqueous solution or a molten salt, it reduces voltage drop due to resistance polarization and should thus be formed as thin as possible. As such, however, small clearances, pores or decants may undesirably be formed. Hence, the solid oxide electrolyte requires homogeneity, density, heat resistance, mechanical strength and stability, as well as ionic conductivity. The material for the electrolyte may include but is not limited to yttria-stabilized zirconia (YSZ) in which yttria (Y₂O₃) is dissolved to about 3 ˜10% in zirconia (ZrO₂).

In order to connect the unit fuel cells 305 in series, the upper support member 306 and the lower support member 307 of the conductive support of the manifold 301 sequentially include an inner connector 308 protruding to be connected to an anode layer of a unit fuel cell and an outer connector 309 protruding to be connected to a cathode layer of another unit fuel cell. The unit fuel cells may be connected in series by means of the protruding inner and outer connectors 308, 309.

Specifically, as shown in the drawing, the inner connector 308 provided at the lower end of the manifold 301 is formed to protrude into a first unit fuel cell 305a and is thus tightly fitted into the anode layer 302. The inner connector 308 of the conductive manifold enables the first unit fuel cell 305a and a second unit fuel cell 305b to be connected in series together with the outer connector 309 which is tightly fitted around the outer surface of the cathode layer of the second unit fuel cell 305b.

An inner connector 308 protruding into the second unit fuel cell 305b from the upper support member of the manifold 301 is tightly fitted into the anode layer of the second unit fuel cell 305b, and the end of the upper portion of the manifold opposite the end having the inner connector 308 is provided in the form of being tightly fitted around the outer surface of the cathode layer 304 of a third unit fuel cell 305c. Thereby, the second and third unit fuel cells may be connected in series.

Likewise, an inner connector 308 protruding from the lower portion of the manifold is tightly fitted into the anode layer of the third unit fuel cell 305c, and the end of the lower portion of the manifold opposite the end having the inner connector 308 is formed to protrude so as to be tightly fitted around the outer surface of the cathode layer of a fourth unit fuel cell 305d.

All of the unit fuel cells 305 disposed in the manifold 301 may be connected in series by means of the conductive manifold 301 and the protruding inner and outer connectors 308, 309 of the manifold 301.

The plurality of unit fuel cells may be connected using only the conductive manifold, and thus series connection thereof may be easily achieved even without the use of an additional current collector. The manifold thus configured is also essentially required to supply fuel to a fuel cell. Therefore, in the present invention intended to accomplish series connection using such a manifold, it is possible to realize both the supply of the fuel and the series connection of unit fuel cells.

Further, a cathode current collector 310 which is connected to the cathode layer is provided at one end of the upper portion of the manifold 301, and an anode current collector 311 which is connected to the anode layer is provided at the other end thereof. The final anode and cathode of the plurality of unit fuel cells connected in series may be easily led out by means of the cathode current collector 310 and the anode current collector 311. In consideration of current collection resistance, it is also possible to additionally connect a lead wire thereto.

Of course, the manifold 301 may include only the inner and outer connectors for series connection, without forming the current collectors at the ends of the upper portion thereof. In this case, the final electrodes may be additionally led out using an electric wire.

Also, the manifold 301 may include insulators 312 at the upper and lower portions thereof in order to prevent the current from shorting. For example, the cathode layer of the third unit fuel cell 305c is connected to the anode layer of the second unit fuel cell 305b by means of the connector, but, in the absence of an insulator, it may be connected to the cathode layer of the first unit fuel cell 305a, undesirably causing a short. Thus, insulators 312 should be essentially provided above all positions of the manifold where the anode layer and the cathode layer are connected to each other so as to prevent the current from shorting. The insulators 312 may be made of mica or glass.

With respect to the shorting of the current, when the unit fuel cells are connected with the manifold, the unit fuel cells may be spaced apart from the manifold 301 at predetermined intervals while being in contact with only the protruding inner and outer connectors 308, 309 of the manifold. This is because the manifold 301 is conductive. For to example, when the anode of the first unit fuel cell 305a and the cathode of the second unit fuel cell 305b are connected to each other, this connection should be achieved through a tight fitting process using only the protruding inner and outer connectors 308 and 309 of the manifold. If not so, anodes and cathodes of respective unit fuel cells may be connected by means of the conductive manifold, undesirably causing a short. Hence, the unit fuel cells are desirably disposed at predetermined intervals as described above. Also, a space between the unit fuel cells and the manifold which are spaced apart from each other may be filled with an insulator material 317.

As shown in FIG. 3, in the present invention, the protruding connectors of the manifold are tightly fitted into the anodes of respective unit cells and tightly fitted around the outer surfaces of the cathodes thereof. Accordingly, there is no need to subject unit fuel cells to complicated procedures such as masking so as to connect them in series, and as well, an additional connector material is no longer required.

The manifold 301 includes a fuel inlet 313 for supplying fuel into the unit fuel cells. The fuel introduced through the fuel inlet 313 may pass through the anode layer of each of the unit fuel cells 305 along a fuel passage formed in the manifold. In this case, the fuel may be discharged through an additional fuel outlet 314 as show in FIG. 3. Alternatively, in the case where an additional fuel outlet 314 is not provided, the introduced fuel may be circulated and then discharged again through the fuel inlet 313, or may be made so as to be maintained in the cell.

The positions of the fuel inlet 313 and the fuel outlet 314 are not limited by the disclosure of FIG. 3.

The unit fuel cells 305 and the connectors of the manifold 301 may be bonded using a brazing process, or using a seal including a high-temperature sealant. The connectors may be in direct contact with the anode layer and the cathode layer of the fuel cells, or otherwise, in order to increase current collection efficiency, may be brought into contact with an anode current collection layer 315 which is provided on the anode layer and a cathode current collection layer 316 which is provided on the cathode layer.

This reduces contact resistance and more efficiently collects the current of respective electrode layers. In addition, in the connection between the connectors 308, 309 of the manifold and the current collection layers 315, 316 of the electrode layers, metal-based ink may be used to thus reduce contact resistance. The metal-based ink may be brought into direct contact with the connection between the connectors 308, 309 and the electrode layers 302, 303 of the unit fuel cells and then sintered, even without the current collection layers 315, 316, thereby reducing contact resistance and enabling the collection of current. The metal-based ink may be any one selected from among metals, metal alloys, mixtures of metal and metal alloy, and mixtures of metal oxide and metal. In consideration of conductive performance and so on, the metal-based ink may include any one selected from among Au, Pd, Pt, Ni, Ru, Rh, Ir and alloys thereof. Taking into consideration the price and so on, Ni is particularly useful.

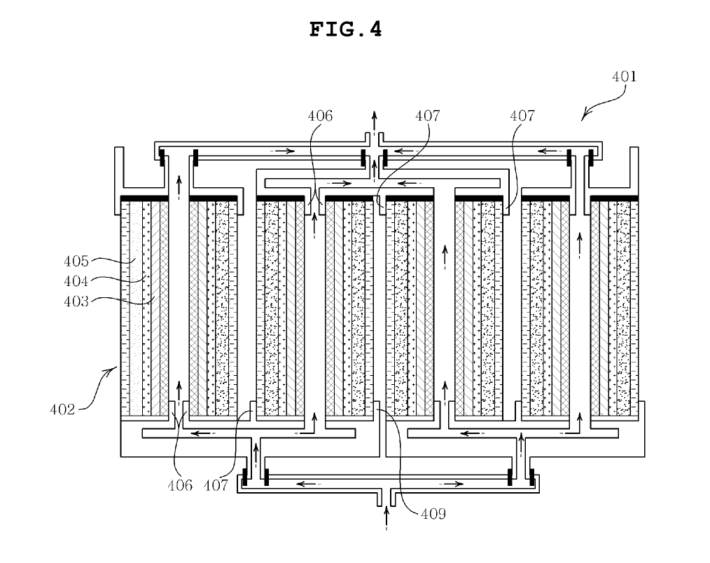

FIG. 4 is a cross-sectional view schematically showing a manifold according to the present invention, in which a plurality of cathode-supported unit fuel cells is disposed.

With reference to FIG. 4, this fuel cell is configured such that an electrolyte layer 404 and an anode layer 405 are sequentially formed on an outer surface of a cathode support 403, unlike the fuel cell shown in FIG. 3. This cathode-supported fuel cell supplies air into unit fuel cells 402 through the manifold 401, unlike the anode-supported fuel cell.

The series connection of the unit fuel cells 402 of the cathode-supported fuel cell is achieved by alternately connecting the protruding inner and outer connectors 406, 407 of the manifold 401 to the cathodes 403 and the anodes 405 of the unit fuel cells 402, as in the anode-supported fuel cell.

Also, a current collector which is connected to the anode layer of the unit fuel cell 402 may be formed at one end of the upper support member of the manifold, and a current collector which is connected to the cathode layer of the unit fuel cell 402 may be formed at the other end thereof. In order to reduce current collection resistance due to the contact between the current collector and the fuel cell and achieve more complete contact and improved current collection efficiency, a lead wire may be additionally used.

The fundamental series connection principle using this manifold is the same as when using the manifold in which the anode-supported fuel cell is disposed, and thus refers to the aforementioned description.

Also, insulators may be provided at upper and lower portions of the conductive manifold 401 in order to prevent the current from shorting.

The cathode-supported fuel cell may further include a current collection layer formed on each of the cathode layer 403 and the anode layer 405 to thus increase current collection efficiency.

Fuel should be provided in a high concentration from outside the cathode-supported fuel cell. In this case, the outside atmosphere of the fuel cell is not an air atmosphere, thus reducing concerns about the oxidation of the current collector, enabling the use of a more inexpensive current collection material, and preventing the oxidation of the manifold 401 made of a conductive material.

The respective electrode layers or the electrode current collection layers and the protruding connectors 406, 407 of the manifold 401 may be bonded using a brazing process, or using a seal including a high-temperature sealant. Although the connectors may be in direct contact with the anode layer and the cathode layer of the fuel cell, in order to increase current collection efficiency, they may be brought into contact with an anode current collection layer which is provided on the anode layer and a cathode current collection layer which is provided on the cathode layer.

This reduces contact resistance and more efficiently collects the current of to respective electrode layers. Additionally, in the connection between the connectors 406, 407 of the manifold and the current collection layers of the respective electrode layers, metal-based ink may be used thus decreasing contact resistance. The metal-based ink is brought into direct contact with the connection between the connectors 406, 407 and the electrode layers 403, 405 of the unit fuel cells and then sintered, even without the current collection layers, thus reducing contact resistance and enabling the collection of current. The metal-based ink may be any one selected from among metals, metal alloys, mixtures of metal and metal alloy, and mixtures of metal oxide and metal. In consideration of conductive performance and so on, the metal-based ink may include any one selected from among Au, Pd, Pt, Ni, Ru, Rh, Ir and alloys thereof. Taking into consideration the price and so on, Ni may be used.

As described hereinbefore, the present invention provides a manifold for series connection of a fuel cell. According to the present invention, a manifold which is essentially manufactured to supply fuel to an SOFC can be used to simply collect current from the SOFC, even without an additional current collector being used. Furthermore, the manifold is configured such that unit fuel cells disposed therein can be connected in series.

Although the embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood as falling within the scope of the present invention.

What is claimed is:

1. A conductive manifold, comprising:
a conductive support including an upper support member and a lower support member between which two or more anode-supported tubular unit fuel cells each comprising an anode layer, an electrolyte layer and a cathode layer formed in sequential order are disposed and which include an inner connector and an outer connector formed to be tightly fitted into an inner surface and around an outer surface of the unit fuel cells so as to electrically connect the unit fuel cells, such that the unit fuel cells are alternately connected with the inner connector and the outer connector at an upper end and a lower end thereof thus forming an electrical series circuit.

2. The conductive manifold as set forth in claim 1, wherein a current collector connected to the cathode layer is formed at one end of the upper support member of the manifold, and a current collector connected to the anode layer is formed at the other end thereof.

3. The conductive manifold as set forth in claim 1, wherein the conductive support comprises an insulator at each of positions where the inner connector and the outer connector are connected to the upper support member and the lower support member in order to prevent current from shorting.

4. The conductive manifold as set forth in claim 1, wherein the unit fuel cells further comprise a current collection layer formed on each of the anode layer and the cathode layer.

5. The conductive manifold as set forth in claim 2, wherein the current collector is connected to the anode layer or the cathode layer using an additional lead wire.

6. The conductive manifold as set forth in claim 1, wherein the manifold has a fuel passage for supplying fuel into the unit fuel cells.

7. The conductive manifold as set forth in claim 1, wherein the unit fuel cells are spaced apart from the upper support member and the lower support member of the conductive manifold by tightly fitting the inner connector and the outer connector of the manifold into and around the unit fuel cells.

8. The conductive manifold as set forth in claim 7, wherein an insulator is fixedly provided at a space between the unit fuel cells and the upper support member and the lower support member of the conductive manifold, which are spaced apart from each other.

9. The conductive manifold as set forth in claim 1, wherein the unit fuel cells and the manifold are bonded using a brazing process.

10. The conductive manifold as set forth in claim 1, wherein the unit fuel cells and the manifold are bonded by bringing conductive ink into direct contact with the unit fuel cells and the manifold and then performing sintering.

11. A conductive manifold, comprising:
a conductive support including an upper support member and a lower support member between which two or more cathode-supported tubular unit fuel cells each comprising a cathode layer, an electrolyte layer and an anode layer formed in sequential order are disposed and which include an inner connector and an outer connector formed to be tightly fitted into an inner surface and around an outer surface of the unit fuel cells so as to electrically connect the unit fuel cells, such that the unit fuel cells are alternately connected with the inner connector and the outer connector at an upper end and a lower end thereof thus forming an electrical series circuit.

12. The conductive manifold as set forth in claim 11, wherein a current collector connected to the cathode layer is formed at one end of the upper support member of the manifold, and a current collector connected to the anode layer is formed at the other end thereof.

13. The conductive manifold as set forth in claim 11, wherein the conductive support comprises an insulator at each of positions where the inner connector and the outer connector are connected to the upper support member and the lower support member in order to prevent current from shorting.

14. The conductive manifold as set forth in claim 11, wherein the unit fuel cells further comprise a current collection layer formed on each of the cathode layer and the anode layer.

15. The conductive manifold as set forth in claim 12, wherein the current collector is connected to the anode layer or the cathode layer using an additional lead wire.

16. The conductive manifold as set forth in claim 11, wherein the manifold has an air passage for supplying air into the unit fuel cells, and an outside atmosphere of the unit fuel cells is a fuel atmosphere.

17. The conductive manifold as set forth in claim 11, wherein the unit fuel cells are spaced apart from the upper support member and the lower support member of the conductive manifold by tightly fitting the inner connector and the outer connector of the manifold into and around the unit fuel cells.

18. The conductive manifold as set forth in claim 17, wherein an insulator is fixedly provided at a space between the unit fuel cells and the upper support member and the lower support member of the conductive manifold, which are spaced apart from each other.

19. The conductive manifold as set forth in claim 11, wherein the unit fuel cells and the manifold are bonded using a brazing process.

20. The conductive manifold as set forth in claim 11, wherein the unit fuel cells and the manifold are bonded by bringing conductive ink into direct contact with the unit fuel cells and the manifold and then performing sintering.
